(19) United States
(12) Patent Application Publication
(10) Pub. No.: US 2024/0315260 A1
(43) Pub. Date: Sep. 26, 2024

(54) LOCKING MECHANISM FOR BREAD MACHINE

(71) Applicant: I-TECH USA, INC., Farmington Hills, MI (US)

(72) Inventor: Sung Hyun Kim, Jeju-si (KR)

(21) Appl. No.: 18/611,119

(22) Filed: Mar. 20, 2024

Related U.S. Application Data
(60) Provisional application No. 63/491,590, filed on Mar. 22, 2023.

(51) Int. Cl. A21C 1/14; A21C 13/00; A21D 8/00

(52) U.S. Cl. CPC A21C 1/149; A21C 1/1405; A21C 1/1465; A21C 13/00; A21D 8/00

(57) ABSTRACT

A bread machine can include a housing, a bread container, a motor, and an electromagnetic locking mechanism. The bread container can be removably disposed within the housing. The bread container can include a paddle disposed within the bread container and a magnetic plate disposed on an exterior of the bread container. The motor can be disposed in the housing and configured to rotate the paddle within the bread container. The electromagnetic locking mechanism can be disposed within the housing and can include an electromagnet. The electromagnet can be configured to selectively engage and disengage the bread container. The electromagnet can be disposed within the housing to correspond with the magnetic plate of the bread container. A method of securing a bread machine for use is also provided.

### CROSS-REFERENCE TO RELATED APPLICATIONS

This application claims the benefit of U.S. Provisional Application No. 63/491,590, filed on Mar. 22, 2023. The entire disclosure of the above application is incorporated herein by reference.

### FIELD

The present technology relates to kitchen appliances and, more specifically, to an electromagnetic locking mechanism for bread machines.

### INTRODUCTION

This section provides background information related to the present disclosure which is not necessarily prior art.

The art of bread making has evolved significantly over the years, transitioning from traditional hand-kneading methods to the use of automatic bread machines designed for home use. Bread machines have simplified the process, making it accessible for individuals to bake fresh bread in the comfort of their own homes. However, despite the advancements in technology, users of automatic bread machines continue to face several challenges that detract from the overall convenience and efficiency of the bread-making process.

One of the primary issues encountered by users of existing bread machines is related to the locking mechanism of the bread container within the machine. The bread container, which holds the ingredients and eventually the loaf of bread, needs to be securely locked in place during the mixing and kneading process. The locking can militate against the container moving or detaching, which could disrupt the bread-making process or even the proper operation of the bread machine. Unfortunately, the locking mechanisms employed in many current models, such as rotating locks or push-and-pull mechanisms with clips, often prove to be less reliable than desired.

Users frequently experience difficulties in engaging and disengaging these locking mechanisms. In some instances, the bread container becomes stuck within the machine due to the locking mechanism failing to release properly. This not only makes the removal of the bread container a frustrating task but also poses a risk of damaging both the bread and the machine. The effort required to dislodge a stuck container can lead to unnecessary wear on the machine's components and, in the worst cases, render the freshly baked bread unusable due to the rough handling required to retrieve it.

The mechanical nature of these locking mechanisms further means that they are prone to wear and tear over time. Repeated use can lead to the mechanisms becoming loose or failing to secure the bread container adequately during the kneading process. This can result in the bread container moving or vibrating excessively, which may affect the quality of the bread dough and, consequently, the final loaf. Additionally, the complexity of these mechanical locking systems often complicates the cleaning process, as users must navigate around these components to ensure the machine is properly maintained.

Accordingly, there is a continuing need for an improved locking mechanism for bread machines. Such a mechanism would ideally allow for the easy and reliable securing of the bread container within the machine, both enhancing the user experience and ensuring the consistent production of high-quality bread. The development of a locking mechanism that addresses these challenges would represent a significant advancement in the field of home bread-making appliances, offering users a more convenient, reliable, and enjoyable bread-making process.

### SUMMARY

In concordance with the instant disclosure, an improved locking mechanism for bread machines, which allows for the easy and reliable securing of the bread container within the machine, has surprisingly been discovered.

The present technology includes articles of manufacture, systems, and processes that relate to an advanced electromagnetic locking mechanism specifically designed for kitchen appliances, with a particular focus on bread machines. This technology addresses the need for a more reliable, user-friendly, and efficient method of securing the bread container during the mixing, kneading, and baking processes. By integrating electromagnetic elements into the locking mechanism, the present technology offers a solution that mitigates the limitations and challenges associated with traditional mechanical locking systems, thereby improving the functionality, safety, and user satisfaction in the operation of bread machines and other kitchen appliances.

In certain embodiments, a bread machine is provided. The bread machine can include a housing, a bread container, a motor, and an electromagnetic locking mechanism. The bread container can be removably disposed within the housing. The bread container can include a paddle disposed within the bread container and a magnetic plate disposed on an exterior of the bread container. The motor can be disposed in the housing and configured to rotate the paddle within the bread container. The electromagnetic locking mechanism can be disposed within the housing and can include an electromagnet. The electromagnet can be configured to selectively engage and disengage the bread container. The electromagnet can be disposed within the housing to correspond with the magnetic plate of the bread container.

In certain embodiments, a method for using a bread machine to bake bread is provided. The method can include providing a bread machine having a housing, a bread container, a motor, and an electromagnetic locking mechanism. The process can include placing ingredients into the bread container and engaging the electromagnetic locking mechanism, effectively locking the bread container within the housing. The method can include kneading the ingredients to form a bread dough, proofing the bread dough, baking the dough into a loaf of bread, and disengaging the electromagnetic locking mechanism to thereby release the bread container.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a schematic diagram of a bread machine including an electromagnetic locking mechanism;

FIG. 2 is a top perspective view of the bread machine;

FIG. 3 is a cutaway view of the bread machine showing a housing, a bread container including rotating shafts having mixing paddles, a motor, and the electromagnetic locking mechanism, taken at line A-A of FIG. 1;

FIG. 4A is a cutaway view of the bread container being placed into the housing, taken at line A-A of FIG. 1;

FIG. 4B is a cutaway view of the bread container being further lowered into the housing where the rotating shafts having the mixing paddles approach engagement with rods powered by a motor, taken at line A-A of FIG. 1;

FIG. 4C is a cutaway view of the bread container secured into the housing where the shafts of the mixing paddles are engaged with the rods, and where the electromagnetic locking mechanism has been engaged, taken at line A-A of FIG. 1;

FIG. 5 is a bottom perspective view of the bread container including a magnetic plate;

FIG. 6A is a top perspective view of a pan stand mount of the electromagnetic locking mechanism including a cover;

FIG. 6B is a top perspective view of a pan stand mount of the electromagnetic locking mechanism without the cover;

FIG. 7 depict a flow diagram for a method of securing a bread machine for use, according to one embodiment; and

FIGS. 8A-8D depict a flow diagram for a method of securing a bread machine for use, according to another embodiment.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present disclosure improves bread machine technologies by introducing an electromagnetic locking mechanism to secure the bread container in the bread machine. The mechanism not only simplifies the process of engaging and disengaging the bread container within the bread machine but also addresses issues associated with mechanical locking systems, such as wear and tear, difficulty in use, and the risk of the bread container becoming stuck. By leveraging electromagnetic forces, the electromagnetic locking mechanism ensures a reliable and user-friendly bread making experience, enhancing the overall bread making experience for users.

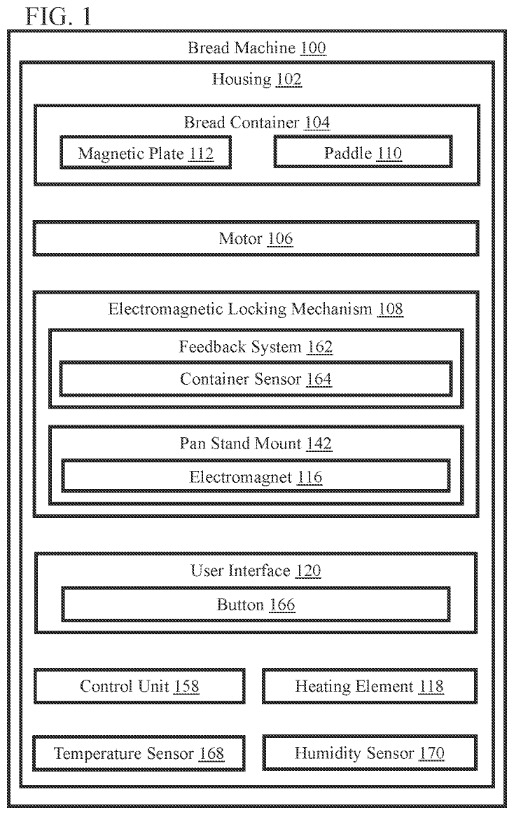

With reference now to the drawings, a bread machine is provided at 100, and shown generally in FIGS. 1-6B. The bread machine 100 can include a housing 102 that can hold a bread container 104, a motor 106, and an electromagnetic locking mechanism 108. The bread container 104 can be removably disposed within the housing 102. The bread container 104 can include a paddle 110 disposed within the bread container 104 and a magnetic plate 112 disposed on an exterior 114 of the bread container 104, as shown in FIG. 3. The motor 106 can be disposed in the housing 102 and can be configured to rotate the paddle 110 within the bread container 104. The electromagnetic locking mechanism 108 can be disposed within the housing 102 and can include an electromagnet 116. The electromagnet 116 can be configured to selectively engage and disengage the bread container 104 from the housing 102. The electromagnet 116 can be disposed within the housing 102 and can cooperate with the magnetic plate 112 of the bread container 104.

With reference to FIG. 3, the housing 102 serves as the structural framework that can contain and support the various components necessary for the bread-making process. The housing 102 can accommodate the bread container 104, the motor 106, and the electromagnetic locking mechanism 108. In addition to the electromagnetic locking mechanism 108, the housing 102 can include other components such as a heating element 118 and a user interface 120.

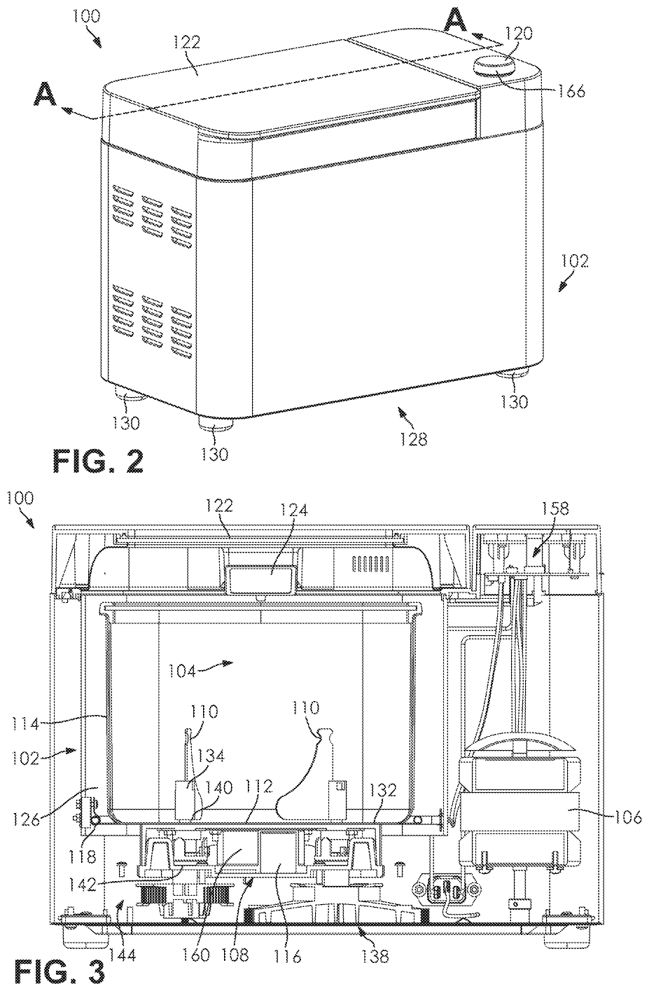

As shown in FIG. 2, the housing 102 can include a lid 122 configured to be selectively opened and closed by the user. The lid 122 can allow the user access to an interior 126 of the housing 102 to allow for the bread container 104 to be placed into and removed from the housing 102. As a non-limiting example, the lid 122 can be hinged or, alternatively, can slide to allow for access to the interior 126 of the housing 102. A skilled artisan can select a suitable type of lid 122 for the housing 102, as desired. In certain embodiments, the housing 102 can further include a latching means 124 for locking the lid 122 where the bread making process has been initiated by the user. Advantageously, the latching means 124 can militate against the housing 102 being opened during the bread making process, preventing access to the bread container 104, and maintaining a predetermined environment within the housing 102 based upon bread making process parameters (e.g., temperature, humidity, etc.).

In certain embodiments, the housing 102 can include a viewing window (not shown) disposed in the lid made of heat-resistant glass to allow users to monitor the bread-making process. The viewing window can militate against the need to open the lid 122 during the bread-making process, which can disrupt the internal temperature and humidity levels critical for achieving optimal bread quality. By providing a way to observe the bread without interfering with the process, users can be reassured that everything is proceeding as expected and make adjustments if necessary, such as stopping the machine if the dough is overflowing.

In certain embodiments, the housing 102 can include a non-slip bottom 128. As a non-limiting example, the non-slip bottom 128 can include a non-slip bottom surface or non-slip fect 130, as shown in FIG. 2. The non-slip bottom 128 can be made from rubber or a similar high-friction material strategically placed at the base of the bread machine 100, as examples. The non-slip bottom 128 can assist in securing the bread machine 100 in place during operation, militating against the bread machine 100 from moving or vibrating excessively on a countertop, especially during the vigorous kneading process. Advantageously, this can promote consistent bread quality by maintaining the correct positioning of the bread container 104 within the housing 102. Moreover, the non-slip bottom 128 can help to reduce noise and absorb vibrations produced by the machine, leading to a quieter and more pleasant kitchen environment.

The housing 102 can be sized to be compact enough for home kitchen use while still being spacious enough to house all necessary components for bread making. The size of the housing 102 can also take into consideration the desired capacity of the bread machine 100. The housing 102 can be configured to hold a bread container 104 for making a bread loaf that ranges between about 1 pound and about 2.5 pounds. A skilled artisan can select a suitable size for the bread container 104 and housing 102 within the scope of the present disclosure. The housing 102 can be made from a heat-resistant, rigid material. As a non-limiting example, the housing 102 can be formed from stainless steel, high-grade plastics, or a combination thereof. Stainless steel offers the advantage of being rust-resistant and easy to clean, while high-grade plastics can provide insulation and reduce the overall weight of the machine. A skilled artisan can select a suitable material for constructing the housing 102 within the scope of the present disclosure.

With reference to FIG. 3, the housing 102 can include the heating element 118. The heating element 118 can provide the necessary heat for both the rising (proofing) and baking stages of the bread making process. The heating element 118 can be disposed within the housing 102, and in certain embodiments, can surround the bread container 104 to promote even heat distribution thereto. Several types of heating elements 118 can be used in the bread machine 100, as non-limiting examples. A resistive heating element, made from materials like nichrome, can be used due to its reliability and cost-effectiveness. The resistive heating element works by converting electrical energy into heat through resistance and as described hereinabove, can surround the bread container 104 or be placed beneath the bread container 104 to promote uniform baking. As another non-limiting example, the heating element 118 can be a quartz heating element, which can heat up quickly and can provide precise temperature control for consistent baking results.

The heating element 118 can be turned on and off at specific times during the bread-making process, controlled by internal circuitry and programming of the bread machine 100. During the initial stages, the heating element 118 can be activated to bring the ingredients to a warm temperature, which is conducive to yeast fermentation and dough rising. Once the dough has sufficiently risen, the heating element 118 can turn on again to bake the bread to the desired crust color and texture. After the baking cycle is complete, the heating element 118 can lower its temperature or turn off, entering a warming phase to keep the bread at an optimal serving temperature without further baking it.

Advantageoulsy, the heating element 118 can be part of a fully automated bread making process, from mixing the ingredients to baking the final product, without the need for an external oven. Additionally, the controlled environment within the bread machine 100 can promote evenly and consistently baked bread, which can be challenging to achieve in a standard oven where hot spots and temperature fluctuations are more common. The internal heating element 118 can also contribute to the compactness and energy efficiency of the bread machine 100, as it heats a small, enclosed space rather than an entire oven cavity. This targeted heating can result in less energy consumption and quicker preheating times.

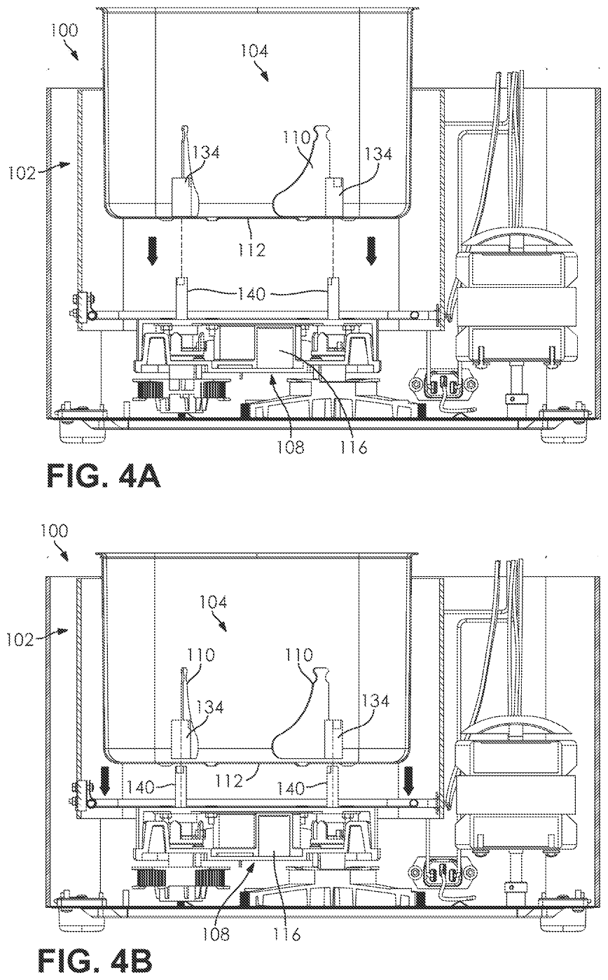

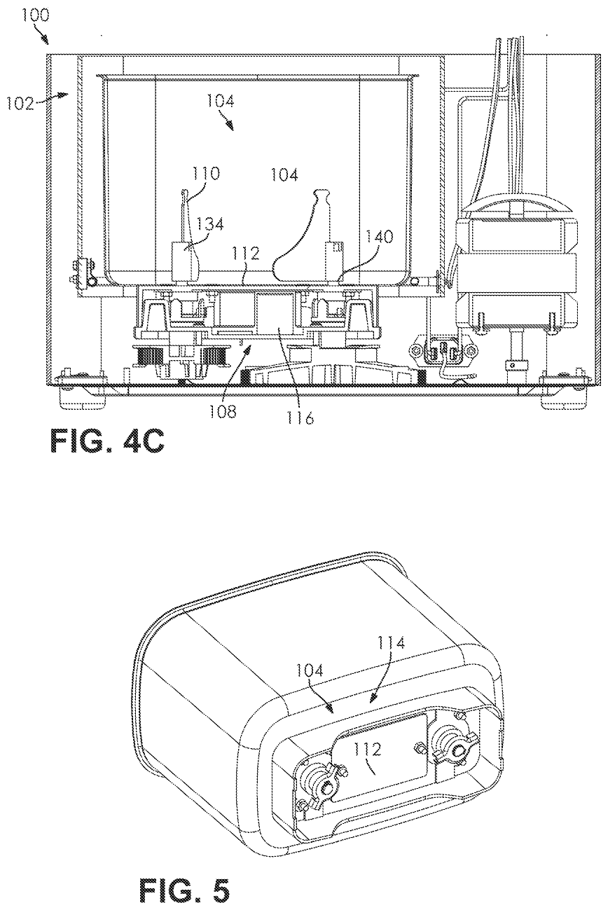

As shown in FIGS. 4A-4C, the bread container 104 can be removably disposed within the housing 102. The bread container 104 can house the ingredients, the bread dough, and the loaf of bread that is formed and baked during the bread making process. The bread container 104 can come in various sizes and shapes to accommodate different bread-making needs. As a non-limiting example, the bread container 104 can range from a small pan that can make a 1-pound loaf, suitable for individuals or small families, to larger pans that can handle 2-pound or even 2.5-pound loaves for larger households or those who want bigger portions. The shape of the bread container 104 can correspond to the desired shape of the loaf, commonly rectangular in cross section to produce a traditional loaf shape, but the bread container 104 can also be shaped as cylindrical or square cross section pans for specialty breads. A skilled artisan can select a suitable size and shape for the bread container 104 such that the bread container 104 can be secured in the housing 102, as desired.

The bread container 104 can be constructed from a durable, heat conductive, and non-stick material. As a non-limiting example, the bread container 104 can be constructed from aluminum or aluminized steel. Advantageously, these materials allow for even heat distribution, which helps in baking the bread evenly. These materials are also lightweight, making it easier to handle the bread container 104 when removing it from the machine. The durability of materials like aluminum ensures that the bread container 104 can withstand repeated use and the high temperatures of baking without warping or degrading. In certain embodiments, the interior of the bread container 104 can be coated with a non-stick material, such as polytetrafluoroethylene (e.g., Teflon™ coating), for example, to militate against the dough and baked bread from sticking to the pan, allowing for an easy release of the loaf and simplifying cleanup. Further, the non-stick coating can reduce the need for additional oil or butter to grease the pan.

As shown in FIG. 3, the bread container 104 can include the paddle 110 disposed within the bread container 104. The paddle 110 can be configured to mix the ingredients to form a bread dough and knead the bread dough to promote gluten formation. The paddle 110 can be disposed on a bottom interior surface 132 of the bread container 104 and can be mounted on a shaft 134 at the bottom of the bread container 104 driven by the motor 106. In certain embodiments, and with reference to FIG. 3, the bread container 104 can include multiple paddles 110. As a non-limiting example, the bread container 104 can include two paddles.

The paddle 110 can come in various shapes, each able to effectively combine ingredients and develop the gluten structure of the dough. Non-limiting examples of paddle 110 shapes include straight, curved, and spiral designs. A straight paddle 110 can be simple and robust, suitable for basic bread recipes. A curved paddle 110 can mimic hand-kneading motions, pushing the dough against the sides of the bread container 104 for better gluten development. A spiral paddle 110 can promote folding the dough onto itself, which can result in a more uniform and airy loaf.

The paddle 110 can advantageously automate the labor-intensive task of mixing and kneading, saving time and effort for the user. This automation can facilitate thorough combination of the ingredients and consistent force being applied to the dough during kneading. Moreover, the bread container 104 allows for a controlled environment during the kneading process. The bread machine 100 can maintain an optimal temperature for yeast activation and gluten development, which can be beneficial in colder climates or during winter months when room temperatures can be too low for effective dough rising. Another advantage of the paddle 110 is that the user can program the bread machine 100 to operate at various speeds and intervals, depending on the bread recipe. For example, some bread types can require a vigorous initial kneading followed by a period of rest and then a gentler second kneading. The paddle 110 can be controlled to accommodate these specific requirements, aiding in optimal bread making techniques, and producing a loaf of bread having certain characteristics desired by the user.

It should also be noted that the bread container 104 can allow for the paddle 110 to be removed before the baking step of the bread making process, to minimizes the hole left at the bottom of the baked loaf. To achieve this purpose, the bread machine 100 can signal to the user that the paddle 110 can be removed at a specific point in the bread making process, such as after the kneading process but before the baking process. The bread machine 100 can release the latching means 124 of the lid 122 to allow for access to the bread container 104 while the electromagnetic locking mechanism 108 remains engaged to militate against the user removing the bread container 104. Optionally, the bread machine 100 can release the latching means 124 of the lid 122 as well as the electromagnetic locking mechanism 108 to allow for the user to remove the entire bread container 104, including the paddle 110. The user can then remove the bread dough from the bread container 104 and remove the paddle 110 before placing the bread dough back into the bread container 104 and placing the bread container 104 into the housing 102. The user can then engage the electromagnetic locking mechanism 108, close the lid 122, and secure the latching means 124 to continue the bread making process.

The bread container 104 can include the magnetic plate 112 disposed on the exterior 114 of the bread container 104, as shown in FIG. 5. The magnetic plate 112 can interact with the electromagnetic locking mechanism 108 of the bread machine 100, ensuring that the bread container 104 is securely held in place during the bread making process and particularly, during the mixing and kneading processes. This configuration not only improves the stability of the bread container 104 but also contributes to the overall efficiency and effectiveness of the bread-making process.

Materials for the magnetic plate 112 can be selected based on their magnetic properties and durability. Non-limiting examples of materials for forming the magnetic plate 112 can include ferrous metals such as steel or iron, which are inherently magnetic and can be easily attracted to an electromagnet. These materials are also robust and can withstand the repeated magnetic forces applied during the operation of the bread machine 100 without significant wear. In certain embodiments, the magnetic plate 112 can be coated or treated to militate against corrosion and to promote a long service life, even under the high humidity conditions typically found inside a bread machine 100 during operation. A skilled artisan can select a suitable material for the magnetic plate 112, as desired.

When the bread container 104 is placed inside the bread machine 100, the magnetic plate 112 can align with an electromagnet 116 of the electromagnetic locking mechanism 108, as shown in FIGS. 4A-4C. Once the user initiates the bread making process, the bread machine 100 can send an electrical current through the electromagnet 116, creating a magnetic field that attracts the magnetic plate 112, thereby securing the bread container 104 in place. The magnetic force ensures that the bread container 104 remains stationary during the vigorous kneading process, militating against the bread container 104 dislodging or moving around, which can disrupt the mixing and lead to inconsistent bread quality.

Returning to FIG. 3, the motor 106 can be disposed in the housing 102 and can be configured to drive the paddle 110 during the mixing and kneading phases of the bread making process. As a non-limiting example, the motor 106 can be an alternating current (AC) motor, a direct current (DC) motor, a stepper motor, or a servo motor. A skilled artisan can select a suitable motor 106 within the scope of the present disclosure. The motor 106 can provide consistent power and handle the varying loads of the bread-making process.

The motor 106 can be coupled to the paddle 110 via a drive system 138 including a rod 140 that corresponds with the shaft 134 of the paddle 110. The coupling translates the rotational motion of the motor 106 into the mixing and kneading action of the paddle 110. The shaft 134 can fit securely onto the rod 140 such that the power output by the motor 106 is delivered effectively to the paddle 110. The coupling can be robust to withstand the forces exerted during kneading. Advantageously, this coupling aids in thoroughly mixing the ingredients and helps to militate against dry spots in the dough and ensuring that the yeast, flour, and other components are evenly distributed throughout the dough. The motor-driven kneading action also develops the gluten network within the dough, which can relate to the texture and structure of the final loaf.

As shown in FIG. 3, the electromagnetic locking mechanism 108 can be disposed within the housing 102. The electromagnetic locking mechanism 108 can include a pan stand mount 142 and the electromagnet 116. The electromagnet 116 can be configured to selectively engage and disengage magnetic plate 112 associated with the bread container 104. The electromagnet 116 can be disposed on the pan stand mount 142 to cooperate with the magnetic plate 112 of the bread container 104. The placement of the electromagnet 116 can correspond with the magnetic plate 112 attached to the bread container 104. This alignment provides for engaging and disengaging the bread container 104 with the electromagnetic locking mechanism 108. When the bread container 104 is inserted into the bread machine 100, the magnetic plate 112 comes into proximity with the electromagnet 116. Once the bread machine 100 is engaged, an electrical current is passed through the electromagnet 116, generating a magnetic field that interacts with the magnetic plate 112, thereby creating an attractive force that holds the bread container 104 securely in place.

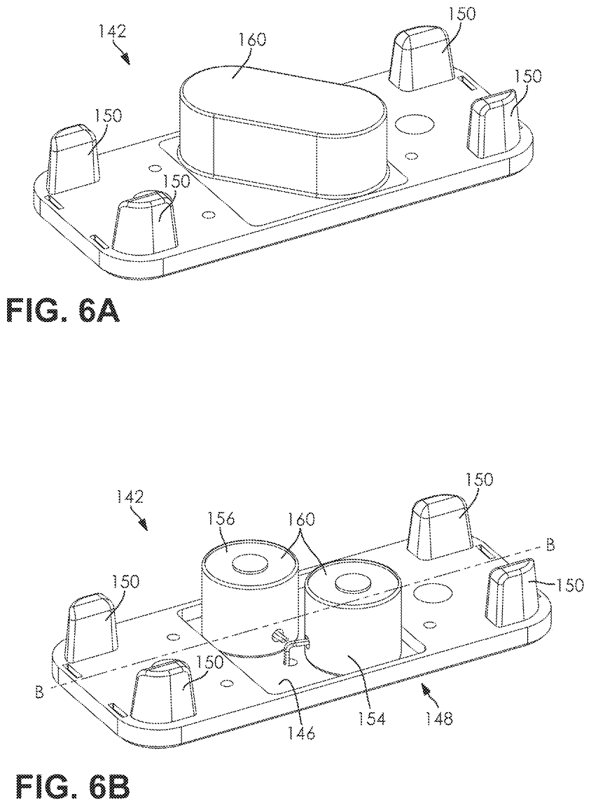

The electromagnetic locking mechanism 108 can include the pan stand mount 142 disposed on an interior base 144 of the housing 102. The pan stand mount 142 can be coupled to the housing 102 via a coupling means such as one or more fasteners (e.g., screws, bolts, etc). The magnetic plate 112 of the bread container 104 can be aligned with a portion of the pan stand mount 142 within the housing 102 when the bread container 104 is inserted into the housing 102. With reference to FIGS. 6A and 6B, the pan stand mount 142 can also house the electromagnet 116 and can include a recess 146 formed in a center area 148 of the pan stand mount 142 in which the electromagnet 116 is disposed. The pan stand mount 142 can include a post 150 disposed at each corner 152 of the pan stand mount 142 and can support the bread container 104 where the bread container 104 is inserted into the housing 102.

Returning to FIG. 4C, the electromagnet 116 can interact with the magnetic plate 112 to engage or disengage the bread container 104 from the housing 102. In certain embodiments of the electromagnetic locking mechanism 108 can include a plurality of electromagnets 116 such that the electromagnetic locking mechanism 108 includes a first electromagnet 154 and a second electromagnet 156, as shown in FIG. 6B. The first electromagnet 154 and the second electromagnet 156 can be disposed diagonally disposed diagonally in relation to the longitudinal axis of the bread container, shown as Axis B in FIG. 6B.

This arrangement allows the electromagnetic locking mechanism 108 to exert a balanced pull on the magnetic plate 112, minimizing the risk of torque or twisting that could occur if the electromagnets 152,154 were aligned linearly or on one side. The diagonal configuration enables the bread container 104 to be held firmly in place, providing a secure grip that counteracts the lateral forces generated during the vigorous kneading process. This not only militates against the bread container 104 shifting or tilting, which could lead to uneven mixing and a suboptimal bread-making process, but also contributes to the longevity of the bread machine 100 by reducing mechanical stress on the components.

The ability to engage and disengage the bread container 104 using the electromagnetic locking mechanism 108 offers several advantages such as allowing for a smoother user experience and minimizes the number of moving parts. Moreover, the electromagnetic locking mechanism 108 can be controlled by a control unit 158 of the bread machine 100, including variations in operating aspects relating to one or more particular programs run by the control unit 158, as described herein. For example, a stronger magnetic force can be applied during the kneading phase to handle the additional movement and vibration, while a decreased force can be applied during the rising and baking phases when the bread dough is relatively still. This dynamic control not only enhances efficiency but also contributes to the longevity of the system by only using as much power as necessary for each stage of the bread-making process.

With reference to FIG. 6A, the electromagnetic locking mechanism 108 can further include a cover 160 disposed over the electromagnet 116. The cover 160 can protect the electromagnet 116 and can act as a shield, militating against debris, flour, and other particulates that could accumulate during the bread-making process from contacting the electromagnet 116 and potentially interfering with the magnetic connection. Additionally, the cover 160 can militate against accidental contact with the electromagnet 116 when the bread machine 100 is in operation or during cleaning and maintenance. The cover 160 can be constructed of a non-ferrous material that does not impede the magnetic field. As a non-limiting example, the cover 160 can be formed from polycarbonate, acrylonitrile butadiene styrene, polypropylene, polyethylene terephthalate, and combinations thereof. A skilled artisan can select a suitable non-ferrous material for the cover 160 within the scope of the present disclosure.

The electromagnetic locking mechanism 108 can further include a feedback system 162 to confirm the engagement or disengagement of the bread container 104. The feedback system 162 can be integrated into the electromagnetic locking mechanism 108 of a bread machine 100 to promote functionality of the appliance. This feedback system 162 can monitor the state of the electromagnetic locking mechanism 108 and provide real-time feedback to the user or the control unit 158. By doing so, the feedback system 162 can incorporate a secondary check that the bread container 104 is securely engaged before the bread making process begins and remains so throughout the various stages of operation. The feedback system 162 can detect whether the electromagnet 116 is properly activated, and the bread container 104 is correctly positioned by monitoring the electromagnetic field created by the electromagnet 116. The feedback system 162 can employ a container sensor 164 or, optionally, sensors, that can detect the presence of the magnetic plate 112 and confirm its alignment with the electromagnet 116. Where the bread container 104 is inserted into the housing 102, the container sensor 164 can check for the correct positioning and the presence of the magnetic field to verify engagement. If the feedback system 162 detects a misalignment or an incomplete magnetic circuit, it can trigger an alert, such as a visual indicator or an audible alarm, for example, to inform the user that the bread container 104 is not properly secured. In certain embodiments, this feedback can also be communicated to a digital display or even transmitted to a mobile device via a connected app, providing convenience and remote monitoring capabilities.

The feedback system 162 can continuously monitor the status of the electromagnetic locking mechanism 108 and can adjust the intensity of the electromagnetic field as needed to accommodate changes in internal pressure or movement within the bread container 104. For instance, during the vigorous kneading phase, the feedback system 162 can increase the locking force to maintain stability, while during the baking phase, a lower force can suffice. The feedback system 162 can also signal the control unit 158 to disengage the electromagnet 116 once the bread-making process is complete, allowing for easy removal of the bread container 104.

It should be appreciated that the intensity of the electromagnetic field generated by the electromagnetic locking mechanism 108 can be adjusted. In this way, the electromagnetic locking mechanism 108 can be configured to vary a locking force during different stages of the bread making process to accommodate changes in internal pressure within the bread container. The control unit 158 can operate the electromagnetic locking mechanism 108 in various ways in in accordance with one or more bread making process programs and/or in response to input through the user interface 120.

In certain embodiments, where the bread machine 100 includes the control unit 158, the control unit 158 can include a microcontroller-based system that can be programmed with various bread-making algorithms to handle tasks such as timing, temperature control, motor operation, and the activation and deactivation of the electromagnetic locking mechanism 108. The control unit 158 can receive input from the user, often through the user interface 120 that can include one or more buttons 166, dials, or a touchscreen, as non-limiting examples, where the user can select the type of bread, crust color, loaf size, and start or delay the baking process. In certain embodiments, programmable settings or custom recipe modes, which the control unit 158 manages by adjusting the operational parameters, accordingly, can be selected by the user.

The control unit 158 can interact with other components of the bread machine 100 to ensure a seamless and efficient baking process. The control unit 158 can control the motor 106, which in turn drives the paddle 110 for kneading the dough. The control unit 158 can determine the duration and speed of kneading, as well as the timing of the resting periods for the dough to rise. The control unit 158 can also regulate the heating element 118, maintaining the appropriate temperature for each stage of the bread making process.

The control unit 158 can be connected to the feedback system 162 and various sensors within the bread machine 100, such as a temperature sensor 168, a humidity sensor 170, and the container sensor 164, described herein. The control unit 158 can process the data received from these sensors to make real-time adjustments to the bread making process. For example, if the temperature sensor 168 indicates that the bread container 104 is too hot or too cold, the control unit 158 can modulate the heating element 118 to correct the temperature. As part of the safety feature, if the feedback system 162 indicates that the bread container 104 is not properly locked, the control unit 158 can prevent a start of the kneading process and alert the user. In certain embodiments with connectivity features, the control unit 158 can communicate with external devices, allowing for remote monitoring and control through a mobile app.

In certain embodiments, the bread machine 100 can include a user interface 120 configured to allow a user to initiate a bread making process. The user interface 120 can allow users to interact with the bread machine 100, providing a means to input commands and receive information. The user interface 120 can be disposed on the exterior of the housing 102 and, in some examples, can be placed on the upper portion of the housing 102, for easy visibility and access, as shown in FIG. 2. The user interface 120 can allow users to select settings, start or pause the bread-making process, and monitor the status of the bread making process. As a non-limiting example, the user interface 120 can include a display, which can be a simple LED or LCD screen, that shows the selected program, baking time, and other relevant information such as the current stage of the bread-making cycle or a countdown timer. The user interface 120 can also include buttons that allow the user to interact with the user interface 120 or the user interface 120 can be a touchscreen. The user interface 120 can also provide feedback to the user, such as alerting when it is time to add mix-ins like nuts or fruits, or when the bread is ready to be removed.

In certain embodiments, the bread machine 100 can further include a plurality of sensors including the container sensor 164, the temperature sensor 168, and the humidity sensor 170, as described herein. The temperature sensor 168 can assist with providing a baking environment that is optimal for the bread making process. The temperature sensor 168 can continuously monitor the internal temperature of the bread machine 100 and provide real-time data to the control unit 158. This allows the bread machine 100 to maintain precise control over the baking conditions, adjusting the heat as necessary to adhere to the specific requirements of the selected bread type and baking stage. For example, during the initial phases, such as preheating and kneading, the temperature sensor 168 can help to maintain a warmer environment conducive to yeast activation and dough rise. During the baking phase, the temperature sensor 168 can determine that the temperature has risen enough to bake the bread thoroughly, while also militating against overheating that could lead to burning or drying out the loaf.

The humidity sensor 170 in the bread machine 100 can play a complementary role to the temperature sensor 168 by monitoring the moisture levels within the bread container 104. Bread making is sensitive to humidity, with the right balance needed to achieve the perfect crust and crumb texture. The humidity sensor 170 can provide feedback to the control unit 158 about the moisture content in the air, which can affect the consistency of the dough and the final bread quality. If the air is too dry, the crust may become too hard, or the bread may not rise properly. Conversely, if there is too much humidity, the bread can turn out too dense or soggy. By adjusting the baking settings in response to the humidity readings, such as altering the output of the heating element 118 or the duration of the baking cycle, the bread machine 100 can compensate for these variables.

In certain embodiments, the bread machine 100 can be configured to communicate with a mobile device to allow remote monitoring and control of the bread machine 100 during the bread making process. The bread machine 100 can communicate with the mobile device enabled through a wireless connection, such as Wi-Fi or Bluetooth™, for example. Through the mobile device, users can start or stop the bread-making process, select recipes, adjust settings, and receive notifications. This connectivity can allow the user to manage the bread making process away from the kitchen. The user can check the progress of their bread, receive alerts when the bread is ready, when it's time to add additional ingredients like nuts or fruits, or if a step in the bread making process is complete or not complete.

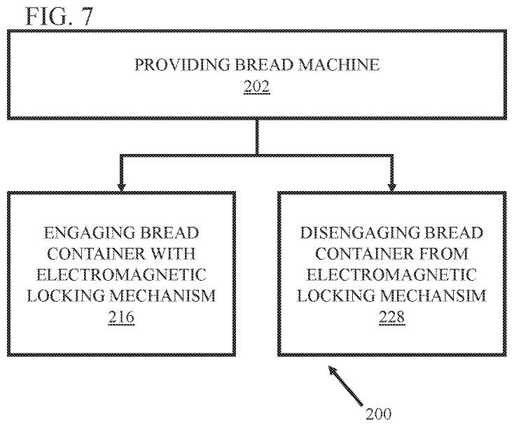

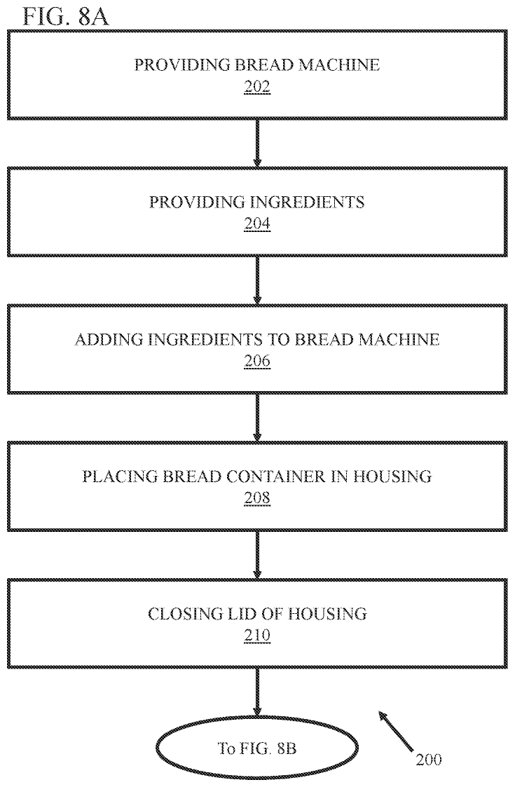

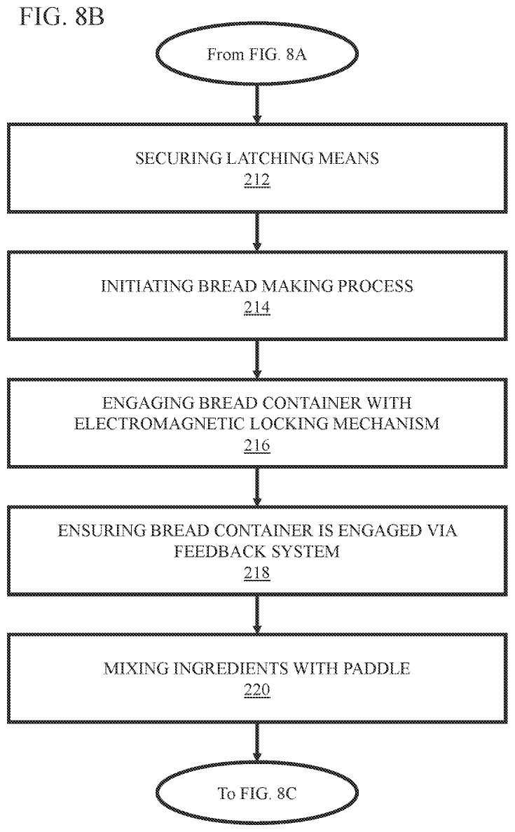

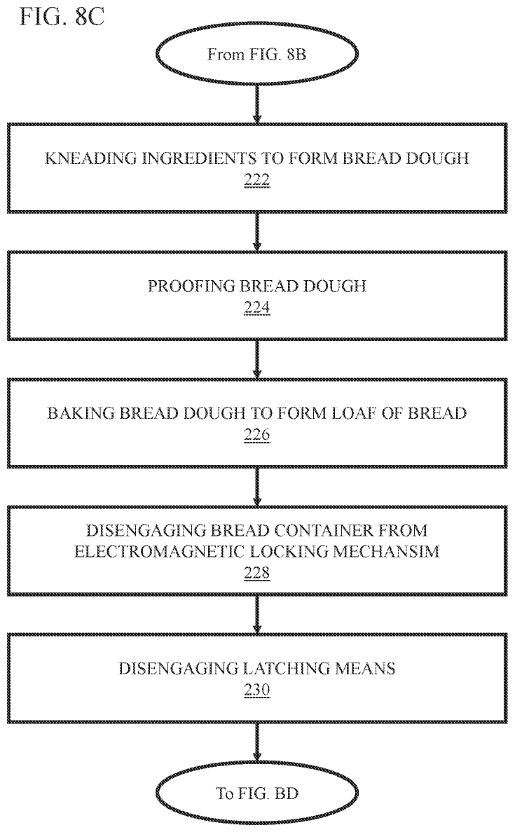

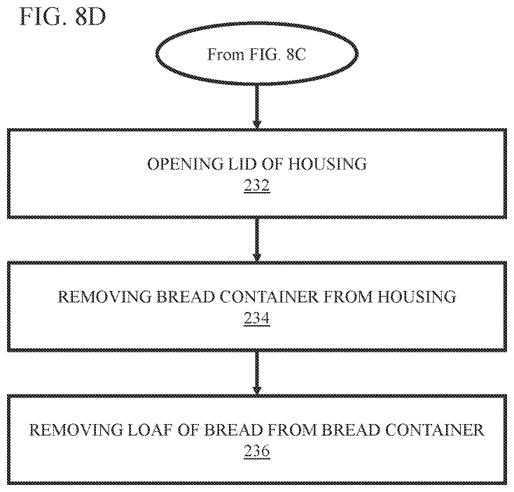

The present disclosure further provides a method 200 of securing the bread machine 100 for use, as shown generally in FIGS. 7 and 8A-8D. The method 200 can include a step 202 of providing the bread machine 100 of the present disclosure. In a step 204, the user can provide the ingredients necessary to make the desired loaf of bread. As a non-limiting example, the ingredients can include water, yeast, honey, sugar, salt, oil, and flour. The user can add the ingredients to the bread container 104 in a step 206. The method 200 can include a step 208 of placing the bread container 104 into the housing 102 and a step 210 of closing the lid 122 of the housing 102. The user can engage the latching means 124 in a step 212 to seal off the housing 102 and prepare for the bread making process to initiate. The method 200 can include a step 214 of initiating the bread making process via the user interface 120. The method 200 can include a step 216 of engaging the bread container 104 with the electromagnetic locking mechanism 108. As described hereinabove, the electromagnetic locking mechanism 108 of the pan stand mount 142 and the magnetic plate 112 of the bread container 104 can work together when aligned to lock the bread container 104 within the housing 102 using an electromagnetic force. As described herein, the electromagnet 116 can be engaged where the electromagnetic locking mechanism 108 is engaged and more than one electromagnet 116 can be engaged as well. It should be appreciated that the step 216 of engaging the electromagnetic locking mechanism 108 can be automatic. In a step 218, the feedback system 162 can ensure that the bread container 104 is securely engaged within the housing 102.

The method 200 can include the bread making process. The bread making process can include a step 220 of mixing the ingredients with the paddle 110 of the bread machine 100. Where the ingredients have been adequately combined, a bread dough is formed. In a step 222, the bread machine 100 can knead the bread dough with the paddle 110 to promote gluten formation. Kneading warms up the strands of gluten, which allows the proteins to expand during fermentation and encourages the molecules to bond, making for a more elastic dough with better structure. In a step 224, the bread machine 100 can allow the bread dough time to proof, or in other words, allow the bread dough time to rest and rise before baking. In certain embodiments, the bread machine 100 can aid the proofing process by slightly warming the bread container 104 to increase fermentation activity. In a step 226 the bread dough can be baked to form a loaf of bread thereby completing the bread making process.

It should be appreciated that certain breads require the kneading and proofing steps to be repeated after an initial knead and an initial proof. To this point, the bread machine 100 can repeat the step 222 of kneading the bread dough and the step 224 of proofing the bread dough before the step 226 of baking the bread dough.

The method 200 can include a step 228 of disengaging the bread container 104 from the electromagnetic locking mechanism 108. As described herein, the electromagnet 116 can be disengaged where the electromagnetic locking mechanism 108 is disengaged. It should be appreciated that the step 228 of disengaging the electromagnetic locking mechanism 108 can be automatic. The method 200 can include a step 230 of disengaging the latching means 124 and a step 232 of opening the lid 122 of the housing 102. The method 200 can include a step 234 of removing the bread container 104 from the housing 102 and a step 236 of removing the loaf of bread from the bread container 104.

The bread machine of the present disclosure including the electromagnetic locking allows for the secured fastening of the bread container during operation improving user safety. The inclusion of a user-friendly interface, which can range from tactile buttons to modern touch screens, allows for easy selection of settings and customization of the bread-making process. The temperature and humidity sensors provide precise control over the baking environment, ensuring consistent quality and texture of the bread. Additionally, the capability to connect to a mobile device for remote monitoring and control adds a layer of convenience, allowing users to engage with the bread-making process from anywhere.

### EXAMPLES

Example embodiments of the present technology are provided with reference to the several figures enclosed herewith.

In a real-world application, a user decides to make homemade bread. The user purchases the bread machine of the present disclosure, particularly due to the electromagnetic locking mechanism. The user decides to make a loaf of bread using the bread machine. After carefully selecting the required ingredients for the loaf, they proceed to add the ingredients into the bread container—flour, water, yeast, a bit of salt, and a touch of honey for sweetness.

As the bread machine begins its cycle, the electromagnetic locking mechanism, featuring multiple electromagnets, engages, securing the bread container firmly in place. This ensures that during the vigorous kneading process, the container remains stable, allowing for optimal mixing and kneading of the ingredients. The user appreciates the lack of noise and movement from the machine, a testament to the effectiveness of the locking mechanism. The control unit of the bread machine, having detected the weight of the ingredients and adjusted the intensity of the electromagnetic field accordingly, proceeds through the kneading, rising, and baking steps. The ambient temperature sensor adjusts the baking time slightly, compensating for the cold air temperature of the kitchen.

After the baking cycle is completed, the bread machine automatically disengages the electromagnetic locking mechanism, signaling that the bread is ready to be removed. The user carefully lifts the bread container out of the machine, impressed that the loaf does not stick to the bread container. As the user slices into the baked loaf, they observe that the crust is crisp, and the interior is soft and fluffy.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A bread machine comprising:
a housing;
a bread container removably disposed within the housing including a paddle and a magnetic plate;
a motor disposed in the housing and configured to rotate the paddle; and
an electromagnetic locking mechanism disposed within the housing and including an electromagnet configured to selectively engage and disengage the magnetic plate of the bread container.

2. The bread machine of claim 1, wherein the electromagnetic locking mechanism includes a plurality of electromagnets.

3. The bread machine of claim 2, wherein the plurality of electromagnets includes a first electromagnet and a second electromagnet disposed diagonally in relation to a longitudinal axis of the bread container.

4. The bread machine of claim 1, wherein the bread container is removable from the bread machine when the electromagnetic locking mechanism is disengaged and the bread container is not removable from the bread machine when the electromagnetic locking mechanism is engaged.

5. The bread machine of claim 1, further comprising a user interface configured to allow a user to initiate a bread-making process.

6. The bread machine of claim 1, wherein the bread machine is configured to provide a signal to disengage the electromagnet following a completion of a bread making process.

7. The bread machine of claim 1, wherein the electromagnetic locking mechanism includes a pan stand mount disposed on a base of the housing, the pan stand mount including the electromagnet.

8. The bread machine of claim 7, wherein the magnetic plate of the bread container is aligned with the pan stand mount including the electromagnet when the bread container is disposed within the housing.

9. The bread machine of claim 7, wherein the electromagnet is disposed in a recess formed in a center area of the pan stand mount.

10. The bread machine of claim 7, wherein the pan stand mount includes a plurality of posts configured to support the bread container when the bread container is disposed within the housing.

11. The bread machine of claim 7, further comprising a cover disposed over the electromagnet.

12. The bread machine of claim 1, wherein the electromagnetic locking mechanism includes a plurality of electromagnets having a first electromagnet and a second electromagnet;
a pan stand mount disposed on a base of the housing, the pan stand mount including the electromagnet and a plurality of posts configured to support the bread container when the bread container is disposed within the housing, the magnetic plate of the bread container is aligned with the pan stand mount including the electromagnet when the bread container is disposed within the housing, the electromagnet is disposed in a recess formed in a center area of the pan stand mount; and
a cover disposed over the electromagnet,
wherein the bread machine is configured to provide a signal to disengage the electromagnet following a completion of a bread making process, and
wherein the bread container is removable from the bread machine when the electromagnetic locking mechanism is disengaged and the bread container is not removable from the bread machine when the electromagnetic locking mechanism is engaged.

13. A method of securing a bread machine for use, the method comprising:
providing the bread machine having:
a housing,
a bread container removably disposed within the housing including a paddle and a magnetic plate,
a motor disposed in the housing and configured to rotate the paddle, and
an electromagnetic locking mechanism disposed within the housing and including an electromagnet configured to selectively engage and disengage the magnetic plate of the bread container; and
one of:
engaging the bread container with the electromagnetic locking mechanism, thereby locking the bread container within the housing; and
disengaging the bread container from the electromagnetic locking mechanism, thereby unlocking the bread container from the housing.

14. The method of claim 13, wherein the step of engaging the bread container with the electromagnetic locking mechanism includes engaging a plurality of electromagnets.

15. The method of claim 13, further including a step of making a loaf of bread by operating the motor to rotate the paddle within the bread container.

16. The method of claim 13, further including a step of providing a signal to disengage the electromagnetic locking mechanism.

17. The method of claim 13, wherein the electromagnetic locking mechanism includes a pan stand mount disposed on a base of the housing and the step of engaging the bread container further includes a step of aligning the magnetic plate with the pan stand mount.

18. The method of claim 13, wherein the steps of one of engaging the bread container and disengaging the bread container occurs automatically by bread machine.

19. The method of claim 13, further including a step of ensuring, by a feedback system, that the bread container is securely engaged.

20. A method of using a bread machine to make a loaf of bread from ingredients, the method comprising:
providing the bread machine having:
a housing,
a bread container removably disposed within the housing including a paddle and a magnetic plate,
a motor disposed in the housing and configured to rotate the paddle, and
an electromagnetic locking mechanism disposed within the housing and including an electromagnet configured to selectively engage and disengage the magnetic plate of the bread container;
providing the ingredients;
adding the ingredients to the bread container;
engaging the bread container with the electromagnetic locking mechanism, thereby locking the bread container within the housing;
mixing the ingredients with the paddle, thereby forming a bread dough;
kneading the bread dough with the paddle;
proofing the bread dough;
baking the bread dough, thereby forming a loaf of bread; and
disengaging the bread container from the electromagnetic locking mechanism, thereby unlocking the bread container from the housing.
